(19) United States
(12) Patent Application Publication
(10) Pub. No.: US 2015/0023581 A1
(43) Pub. Date: Jan. 22, 2015

(54) METHOD FOR GENERATING AN ELECTRONIC/DIGITAL BANKNOTE AND MACHINE FOR CARRYING OUT THE SAID METHOD

(71) Applicant: Roberto Giori, Monaco (MC)

(72) Inventor: Roberto Giori, Monaco (MC)

(21) Appl. No.: 14/383,652

(22) PCT Filed: Mar. 6, 2012
(86) PCT No.: PCT/EP2012/053822

§ 371 Date: Oct. 1, 2014

(51) Int. Cl. G06Q 20/06; G06Q 20/40; G01J 1/42; G06Q 20/36

(52) U.S. Cl. CPC G06Q 20/0655; G06Q 20/3678; G06Q 20/40; G01J 1/42
USPC 382/135; 705/35

(57) ABSTRACT

A method for generating electronic/digital banknote, includes the steps of:
a) collecting physical and/or numeric parameters of an existing banknote;
b) using a first algorithm saved on a file store of a first computer element for generating a first code based on at least some of the collected parameters;
c) using a numbering algorithm saved on a file store of a second computer element for generating a unique code number;
d) combining the first code with the code number and generating a hashed and unique second code which integrates data of the collected parameters; and
e) attributing the second code to an electronic/digital banknote.

### TECHNICAL FIELD

The present invention relates to the technical field of the generation of electronic or digital money. The aim of such electronic money is to replace partly and progressively the use of classical banknotes. It seems that there is a real need for efficient and secured systems which generate electronic/digital money and which could take an increasing part in the organization of financial flows and transactions worldwide.

The present invention concerns more particularly a novel method for generating electronic/digital money and in particular electronic/digital banknotes.

The present invention entails a new electronic method of coding that begins from the “birth” or creation of the electronic/digital banknote, which contains among many elements, the essential codes for government organizations/Central Banks to control the flow of money worldwide. The architecture of this system will greatly facilitate the management of enormous information flows to these institutions as well as the establishment of statistics regarding these financial transactions and flows.

As with the traditional banknote that flows in an “open loop”, the advantage of the electronic/digital banknote, called Giori-Money, in the present invention, is that it, too, operates on the same principle. Giori-Money is as internationally recognized as banknotes are and flows between parties as banknotes currently do—in an “open system.” Giori-Money, however, has the added benefit of leveraging the latest advancements in technology to be an effective, traceable financial instrument that can be managed as surplus banknotes by Central Banks under the umbrella of one, unique global standard.

The present invention concerns also a machine for carrying out the above mentioned method and so generating secured electronic/digital banknotes.

The increasing part of electronic devices for communicating in everyday life helps to understand how such electronic/digital money could facilitate financial transactions.

### BACKGROUND OF THE INVENTION

Many attempts for generating electronic money have been made. The systems on which these electronic monies are based have also tremendous drawbacks especially with respect to counterfeiting or with respect to the security of the transaction, circulation and traceability of these electronic monies.

The majority of these systems operate in closed loop systems whereby transactions can only be effectuated within a specified network hence limiting the overall durability, usability and interoperability of these electronic monies.

### OBJECTS AND SUMMARY OF THE INVENTION

Consequently, an object of the present invention is to propose a new and safe method for generating electronic/digital banknotes that does not present the above-mentioned drawbacks and that is particularly simple to implement.

Another object of the present invention is to propose a novel method for generating electronic/digital banknotes that cannot be forged or counterfeited.

The object of the present invention is therefore to propose a new method for generating electronic/digital banknotes, which is easy to carry out and which also involves very low operating costs.

Another object of the present invention is to propose a novel machine for carrying out the said method.

Another object of the present invention is to propose a novel machine for generating electronic/digital banknotes, which is reliable, adaptative and cost effective.

The objects given to the invention are achieved with the help of a method for generating electronic/digital banknotes, comprising the steps of:
a) collecting physical and/or numeric parameters of an existing banknote,
b) using a first algorithm saved on a file store of a first computer means for generating a first code based on at least some of the collected parameters,
c) using a numbering algorithm saved on a file store of a second computer means for generating a unique code number,
d) combining the first code with the code number and generating a hashed and unique second code which integrates data of the collected physical and/or numeric parameters,
e) and attributing the second code to an electronic/digital banknote.

The electronic/digital banknotes generated at the Central Bank level, will hence progressively become a substitute or replacement for existing banknotes (or paper money).

In an implementation in accordance with the invention, the method consists in using the first computer means for carrying out the steps d) and e).

In an implementation in accordance with the invention, the method comprises the step of using a first algorithm which generates a random code based on hashed and/or converted data of the collected physical and/or numeric parameters.

In an implementation in accordance with the invention, the method comprises the step of using a numbering algorithm which generates a unique and random code number which is combined to the first code.

In an implementation in accordance with the invention, the method comprises the step of storing the second code on a readable support within a safe and secured environment.

In an implementation in accordance with the invention, the method comprises the step of using the second code for the identification of an electronic/digital banknote and for the authentication of a numeric transfer of electronic/digital banknotes.

In an implementation in accordance with the invention, the method comprises the step of using sensed physical parameters of a real banknote sheet produced in a classical banknote production line, prior to the numbering step of the said banknote.

In an implementation in accordance with the invention, the method consists in using random fluctuations of the structural and/or printing parameters, which occur during the classical fabrication of a real banknote, for constituting at least some of the collected physical parameters.

In an implementation in accordance with the invention, the method consists in destroying the banknote sheet after the parameters have been collected.

In another implementation in accordance with the invention, the method comprises the step of using sensed physical parameters from a physical banknote specimen of an existing banknote.

In another implementation in accordance with the invention, the method comprises the step of using numeric parameters, generated by CAD means, defining a real banknote sheet which is produced in a classical banknote production line.

In another implementation in accordance with the invention, the method comprises the step of using sensed physical parameters a physical banknote specimen of an existing banknote sheet and the step of using numeric parameters, generated by CAD means defining the existing banknote sheet which is produced in a classical banknote production line.

In an implementation in accordance with the invention, the method comprises the step of using the numbering means of a classical banknote production line for generating the unique code number.

The objects given to the invention are achieved with the help of a machine for generating an electronic/digital banknote especially by carrying out the method in accordance to any one of the claims 1 to 13, comprising:
means for collecting physical and/or numeric parameters of an existing banknote,
a first computer means comprising a file store in which is saved a first algorithm for generating a first code based on at least some of the collected parameters,
a second computer means comprising a file store in which is saved a numbering algorithm for generating an unique code number,
and software means for combining the first code with the code number for generating a hashed and unique second code and for attributing said second code to an electronic/digital banknote.

In an embodiment of the machine in accordance with the invention, the software means are loaded on the first computer means.

In an embodiment of the machine in accordance with the invention, the first computer means are integrated in a tamper proof black box.

In an embodiment of the machine in accordance with the invention, the means for collecting parameters comprise optical and/or electromagnetic sensor means for recognizing physical parameters of an existing banknote.

In an embodiment in accordance with the invention, the machine comprises:
an input system for banknote sheets,
a transparent cylinder for transporting the sheets within the sensing area of the sensor means, in order to analyze the said sheets and to collect their physical parameters,
and an extraction cylinder for picking up the sheets from the transparent cylinder after being analyzed and for feeding an evacuation system with the analyzed sheets.

In an embodiment of the machine in accordance with the invention, it comprises an additional cylinder cooperating with the extraction cylinder for turning the sheets after the analysis of their first side and for disposing the other side of the said sheets on the transparent cylinder for a complementary analysis.

In an embodiment of the machine in accordance with the invention, the sensor means comprise a linear camera and a visible light reflection illuminator arranged outside the transparent cylinder.

In an embodiment of the machine in accordance with the invention, the sensor means comprise an infrared or ultraviolet light transmission illuminator arranged in the transparent cylinder, in a position which allows the emission of a transmitted beam of light in the direction of the linear camera.

In an embodiment of the machine in accordance with the invention, the evacuation system comprises a translation table for conveying the sheets to a cutting unit for destroying the analyzed sheets.

In an embodiment of the machine in accordance with the invention, it comprises connection and communication means for establishing a data transmission between a remote CAD device and the first computer means, the data corresponding to the numeric parameters of an existing banknote being stored in the CAD device.

An advantage of the method in accordance with the invention as well as the machine in accordance with the invention lies in the fact that they can be combined or integrated in existing production lines of classical banknotes and thus without any transformation of the said existing production lines.

Another advantage of the machine in accordance with the invention lies in the fact that its operation takes place under the entire supervision and control of the central banks or another authority.

Another advantage of the method and of the machine in accordance with the invention lies in that a central bank cannot generate unauthorized electronic/digital banknotes, due to the fact that the said central bank does not have access to all the means (first algorithm) which are necessary to generate the second code defining an electronic/digital banknote. Even a central bank cannot duplicate or reproduce an already existing digital banknote since its second code is unique and registered. Additionally, the withdrawal of old banknote sheets is no more necessary for digital banknotes.

Another advantage of the machine in accordance with the invention lies in that its technical features can be adapted to every kind of existing and classical banknotes and so be optimized for every central bank in the world.

### BRIEF DESCRIPTION OF THE DRAWINGS

The invention and its advantages also appear in greater detail from the following description of an embodiment given by way of illustration and with reference to the accompanying figures in which:

FIG. 1 is a flow diagram illustrating the method in accordance with the invention,

FIG. 2a is a flow diagram illustrating the method in accordance with the invention, using a first embodiment of a machine in accordance with the invention which is integrated in a classical production line of current banknotes,

FIG. 2b is a flow diagram illustrating the method in accordance with the invention, using a second embodiment of a machine in accordance with the invention which is integrated in a classical production line of current banknotes,

FIG. 2c is a flow diagram illustrating the method in accordance with the invention, using a third embodiment of a machine in accordance with the invention which is integrated in a classical production line of current banknotes,

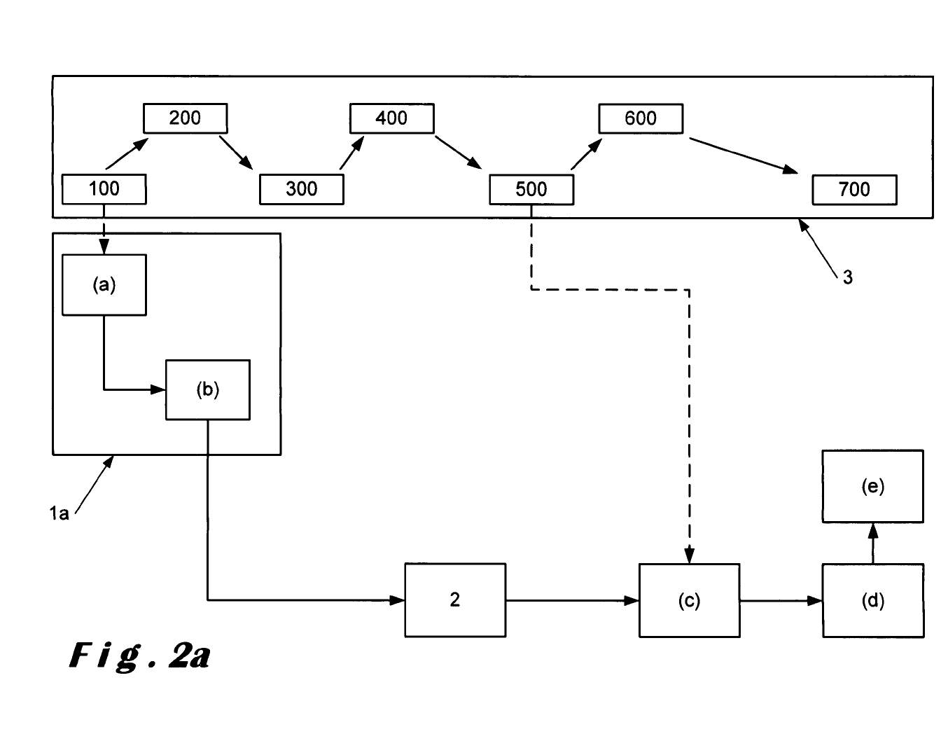

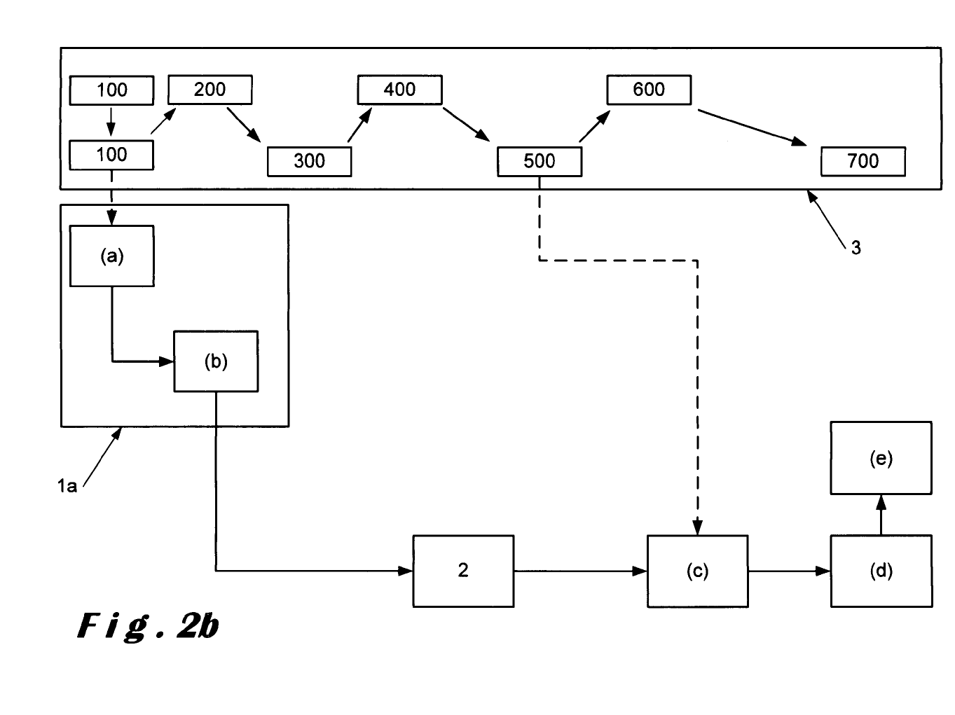

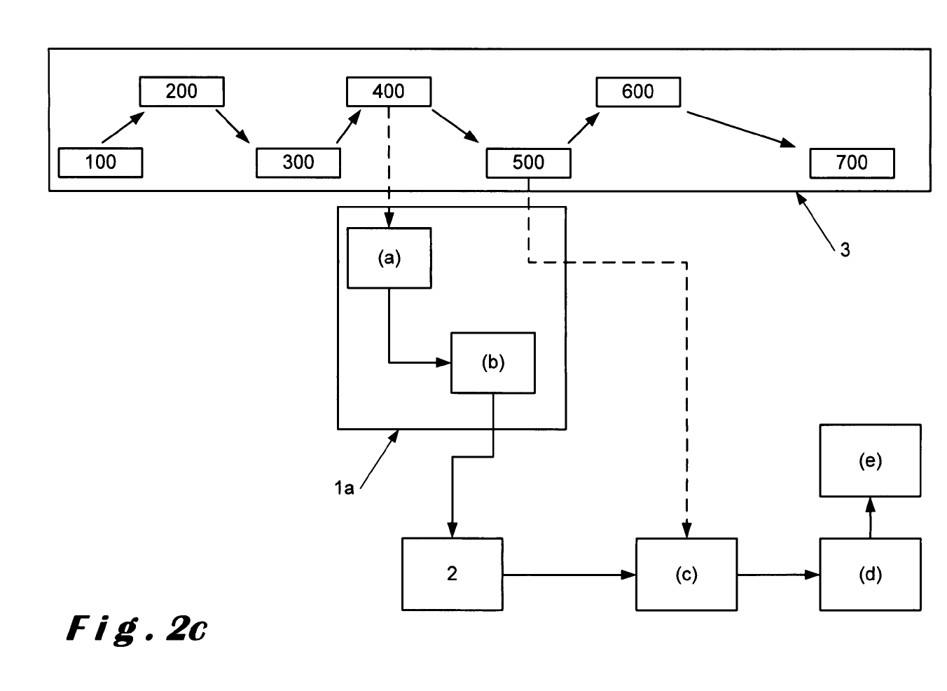

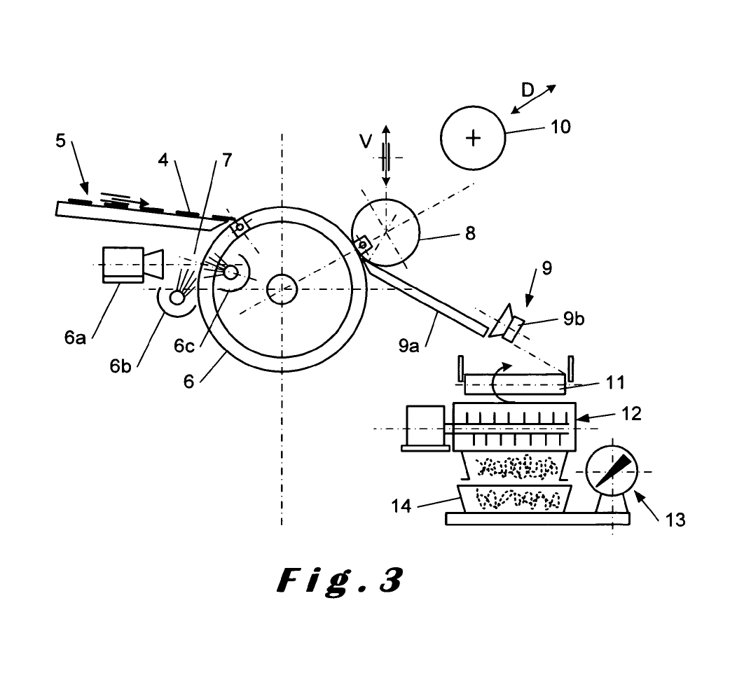

and FIG. 3 is an illustration of the third embodiment of the machine in accordance with the invention of FIG. 2c.

### DETAILED DESCRIPTION

Elements that are structurally and functionally identical, and that are present in more than one distinct figure or illustration, are given the same numeric or alphanumeric reference in each of them.

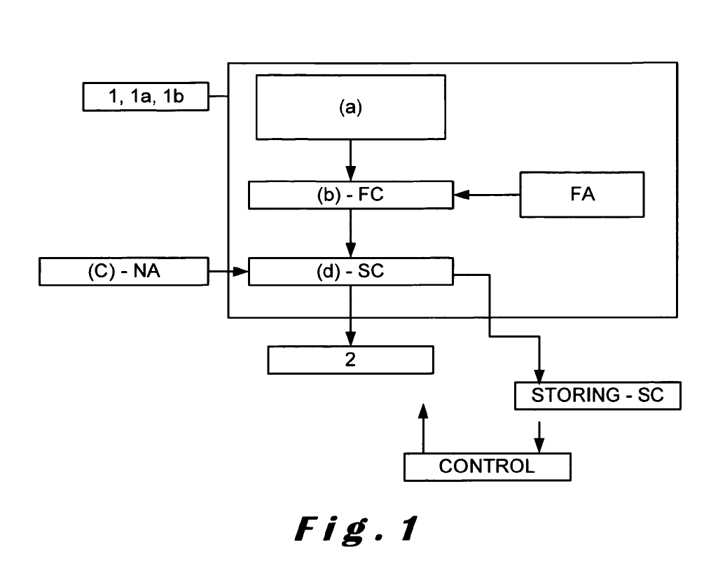

FIG. 1 is a flow diagram illustrating the method in accordance with the invention. The method in accordance with the invention is carried out with the help of a machine 1.

This method, which allows generating an electronic/digital banknote, comprises a step a) of collecting physical and/or numeric parameters of an existing banknote.

The method comprises also a step b) of using a first algorithm FA, which is saved on a file store of a first computer means for generating a first code FC based on at least some of the collected parameters. This first code FC is also called “DNA-Code”. The first computer means is advantageously integrated in or associated to the machine 1.

The method comprises then a step c) of using a numbering algorithm NA, saved on a file store of a second computer means for generating a unique code number. Such a numbering algorithm is for instance stored in numbering means of a classical banknote production line for generating the unique code number. Such numbering operations are well known.

The method comprises then a step d) combining the first code with the code number and generating advantageously a hashed and unique second code SC which integrates data of the collected parameters.

The method comprises then a step e) of attributing the second code SC to an electronic/digital banknote 2.

In an implementation in accordance with the invention, the method consists in using the first computer means for carrying out also the steps d) and e).

The first algorithm FA generates for instance a random first code FC based on hashed and/or converted data of the collected parameters.

In an implementation in accordance with the invention, the method comprises the step of using the numbering algorithm NA, generating a unique and random code number which is combined to the first code FC. The code number is a number of the kind generated by the central banks for the current and existing printed banknotes. An already existing numbering algorithm of a central bank can be used for the generation of the code number which will be combined with the first code FC.

In an implementation in accordance with the invention, the method comprises the step of storing the second code SC on a readable support within a safe and secured environment. Such a support is housed preferably within a central bank.

In an implementation in accordance with the invention, the method comprises the step of using the second code SC for the identification of an electronic/digital banknote 2 and for the authentication of a numeric transfer of electronic/digital banknotes 2. Such a step is obviously undertaken with the help of corresponding encrypted communication means.

In an implementation in accordance with the invention, the method comprises the step of using sensed physical parameters of a real banknote produced in a classical banknote production line, prior to the numbering step of the said banknote. These physical parameters comprise for instance transparency or mapping parameters, color parameters, numbering parameters, deep engraving parameters or any other parameter or any combination of such parameters.

In an implementation in accordance with the invention, the method comprises the step of using random fluctuations of the structural and/or printing parameters, which occur during the classical fabrication of a real banknote (paper banknote), for constituting at least some of the collected parameters. Such fluctuations can for instance concern colour, holes, design, pattern or any other parameters or combination of parameters.

In an implementation in accordance with the invention, the method comprises the step of destroying the banknote sheet after the parameters have been collected. The banknote sheet with its corresponding and unique fabrication fluctuations cannot be used again for the generation of another and consequently illegal electronic/digital banknote 2.

In another implementation in accordance with the invention, the method comprises the step of using numeric parameters, generated by CAD means (computer assisted designing means), defining a real banknote sheet which is produced in a classical banknote production line. These numeric parameters comprise for instance transparency or mapping parameters, color parameters, numbering parameters, deep engraving parameters or any other parameter or any combination of such parameters.

FIG. 2 is a schematic and functional illustration of an embodiment of a machine 1a or 1b in accordance with the invention, integrated in a classical production line 3 of current banknotes. The machine 1a or 1b allows for the defining of the digital banknote 2 for which the unique second code SC will be generated.

The classical production line 3 comprises for instance means for undertaking successive operations or fabrication steps corresponding to a standard banknote printing process.

Such a standard process comprises for instance the following steps:
100) a computer aided designing step (CAD), that consists in designing a banknote sheet in its structure, color and other printing parameters,
200) an offset step,
300) a silkscreen step,
400) intaglio step,
500) a numbering step, which consists of attributing a code number to the banknote,
600) and 700) other steps which consist of other security elements in banknote production.

The above mentioned steps 100) to 700) are well known in current banknote production.

The machine 1a according to its implementation illustrated in FIG. 2a, takes the numeric parameters of the existing banknotes directly after the step 100) from the standard banknote printing process, in particular from a CAD means, for undertaking the step a) of the method in accordance with the invention.

In the embodiment of FIG. 2a, the means for collecting the data corresponding to the numeric parameters comprise connecting means to the CAD means and specific software means of the first computer means.

The machine 1a according to its implementation illustrated in FIG. 2b, takes the physical parameters of the existing banknote specimen directly after a step 110) from the standard banknote printing process, which consists in fabricating the said specimen, for undertaking the step a) of the method in accordance with the invention. Such a specimen fabrication is driven for instance by CAD means. The banknote specimen has all the parameters of a real banknote sheet.

In the embodiment of FIG. 2b, the means for collecting the data corresponding to the physical parameters of the specimen, comprise scanning means connected to the first computer means. The means for collecting parameters comprise optical and/or electromagnetic sensor means for recognizing physical parameters of a specimen.

The machine 1b according to its implementation illustrated in FIG. 2c, takes the physical parameters of the existing banknote sheets 4 directly after the step 400), prior to the numbering operation of the standard banknote printing process. The code number resulting of the step c) is issued by the numbering algorithm of the standard banknote printing process in step 400).

In the embodiments of FIG. 2c, the means for collecting the data corresponding to the physical parameters of the paper banknote sheet (existing banknote) comprise scanning means connected to the first computer means. The means for collecting parameters comprise for instance optical and/or electromagnetic sensor means for recognizing physical parameters of an existing banknote.

FIG. 3 is a schematic illustration of another embodiment of the machine 1b in accordance with the invention.

The machine 1b for generating an electronic/digital banknote 2, especially by carrying out the method as described above, comprises means for collecting physical and/or numeric parameters of an existing banknote sheet 4. The means for collecting the parameters comprise advantageously optical and/or electromagnetic sensor means for recognizing physical and/or structural parameters of the existing banknote sheet 4.

In an embodiment in accordance with the invention, the machine 1b comprises an input system 5, such as a conveyor, for banknote sheets 4.

The machine 1b comprises also a transport cylinder, for instance a transparent cylinder 6, for transporting the sheets 4 within a sensing area 7 or an acquisition area of the sensor means, in order to analyze the said sheets 4 and to collect at least some of their physical parameters.

The transparent cylinder 6 presents going through apertures or through holes onto which is applied a vacuum. Corresponding means for generating a vacuum such as a vacuum clipping system is already known in such applications.

In an embodiment, the sensor means comprise a linear camera 6a and a visible light reflection illuminator 6b, arranged outside the transparent cylinder 6. The beam of visible light delimitates the sensing area 7 on the outer surface of the transparent cylinder 6.

In an embodiment, the sensor means comprise an infrared or ultraviolet light transmission illuminator 6c, arranged in the transparent cylinder 6 and more precisely in a position which allows the emission of a transmitted beam of light in the direction of the linear camera 6a.

In an embodiment, the sensor means may use different wavelengths or a specific wavelength.

The machine 1b comprises also an extraction cylinder 8 for picking up the sheets 4 from the transparent cylinder 6 after being analyzed and for feeding an evacuation system 9 with the analyzed sheets 4.

The extraction cylinder 8 has for instance a smaller diameter than the transparent cylinder 6 and can be moved in a vertical direction V for its positioning with respect to the said transparent cylinder 6.

In embodiment in accordance with the invention, the machine 1b comprises an additional cylinder 10 cooperating with the extraction cylinder 8 for turning the sheets 4 after the analysis of their first side and for disposing their first side on the transparent cylinder 6 for an analysis of their second side. The additional cylinder 10 can advantageously be driven between a remote position, a first position in contact with the extraction cylinder 8 for picking up the sheets 4 and a second position in contact with the transparent cylinder 6 for disposing the other side of the sheets 4 on the said transparent cylinder 6. Both sides of a banknote sheet 4 can so be analyzed.

The additional cylinder 10 has for instance a smaller diameter than the transparent cylinder 6 and may be moved for instance in at least one direction D, for its positioning with respect to the said transparent cylinder 6 and for its positioning with respect to the extraction cylinder 8.

The vacuum means are used also for fixing the sheets 4 on the outer surface of the extraction cylinder 8 and of the additional cylinder 10.

The evacuation system 9 comprises a translation table 9a for conveying the sheets 4 to cutting blades 9b to reduce the sheets 4 into strips and so destroying the analyzed sheets 4. The cutting blades 9b are advantageously associated to a conveyor belt 11 for conveying the strips to a grinder 12 that reduces the strips into small pieces of less than 3 mm in dimension.

The machine 1b comprises also in an embodiment, a precision weighing system 13 for weighing the reduced pieces coming from the grinder 12. One can be sure that all sheets 4 that have been analyzed are destroyed and cannot be used again.

The analyzed sheets 4 will so be expelled from the transparent cylinder 6 where the extraction cylinder 8 will take the said sheets 4 by means of a vacuum clipping system and transport them to the translation table 9a. The strips of the sheets 4 will then fall by gravity on the conveyor belt 11 which will feed the grinder 12. The sheets 4 are then reduced in pieces of sufficiently small dimensions for complying with current regulations of banknote destruction. The end pieces will be collected in a stainless steel container 14. The precision weighing system 13 will then validate that the sheets 4, used to create the digital banknotes 2 have been destructed. This validation occurs only when the initial data of the actual weight of the sheets 4 and the weight of the extracted pieces will be consistent. The machine 1b will then validate the acquisition of the parameters and allow going on with a next stage of encryption.

The machine 1b comprises also driving means for controlling the operation of the transparent cylinder 6, the extraction cylinder 8, the additional cylinder 10, the linear camera 6a as well as the vacuum means.

The machine 1b comprises also first computer means comprising a file store in which is saved the first algorithm FA for generating the first code FC based on at least some of collected parameters.

The machine 1b comprises also second computer means comprising a file store in which is saved the numbering algorithm NA for generating the unique code number. The second computer means could also be associated to the machine 1a or 1b and located in a remote location, for instance within a central bank.

The machine 1b comprises also software means for combining the first code

FC with the code number for generating a hashed and unique second code SC and for attributing said second code SC to an electronic/digital banknote 2. This software means is for instance loaded on the first computer means.

The first computer means are advantageously integrated in a tamper proof black box. Only the manufacturer of the machine 1b or 1a will so have knowledge of what is housed in said black box, especially of the detailed instructions constituting the first algorithm FA.

The machine 1a is an embodiment comprising connection and communication means for establishing a data transmission between a remote CAD device and the first computer means, the data corresponding to the numeric parameters of an existing banknote being stored in the CAD device. Some of the numeric parameters can so be used for generating the first code FC.

In an implementation in accordance with the invention, the method of generating digital banknotes 2 is carried out as described below.

The sheets 4, extracted from the production line at step 400) before the numbering stage but completely printed, are deposited on the input unit 5.

The sheets 4 are taken from the transparent cylinder 6 with the help of the vacuum clipping system that guarantees the blocking of the sheets 4. The sheets 4 are then moved from the transparent cylinder 6 so that they will pass through the data acquisition area or sensing area 7 where the sensor means provide a multispectral group of scanned images in high definition (RGB, IR) of the entire sheets 4. The group includes a color image (or RGB) acquired in reflected visible light and and/or in transmitted infrared light.

Alongside the acquisition or sensing area 7, the speed of the sheets 4 which is modified in a “pseudo-random” way, is the multispectral acquisition, which is occurring via linear scans at a constant frequency.

This acquisition technique of each acquired image that contains a pseudo-random modification component is unique and cannot be duplicated. Any subsequent acquisition will have different random movement characteristics and will synchronize differently with the position of the sheets 4.

Due to the high resolution of the images, the acquired data contains information relative to unique structural characteristics of the sheets 4 in consideration. These characteristics, also called physical parameters, are generated from the random fluctuations of the production processes of the sheets 4. Such fluctuations comprise for example, random variations in the composition of the substrate and random variations or pseudo-random variations generated during the printing process. The size, complexity and randomness of these fluctuations, could also be used like a digital fingerprint of the sheets 4.

The information acquired in accordance with the invention is then characterized in a unique way and cannot be duplicated since it includes the effect of the random variations of the movement of the sheets 4.

The multispectral image of the paper or sheet 4 is then sent to a data processing system or first computer means, where it is analyzed and stored permanently in a mass storage backup system. Hence the unique image remains the only element associated with the second code SC.

In an implementation in accordance with the invention, through the analysis of information, defined and constant elements are preferably removed while essential data associated with random variations of the printed structure of the substrate or sheet 4 are extracted.

Naturally, the present invention can be subjected to numerous variations as to its implementation. Although several embodiments and implementations are described above, it should be understood that it is not conceivable to identify exhaustively all possible variants. It is naturally possible to envisage replacing any of the means described or any of the steps described with equivalent means or an equivalent step, without going beyond the scope of the present invention.

1-23. (canceled)

24. Method for generating electronic/digital banknote, comprising the steps of:
a) collecting physical and/or numeric parameters of an existing banknote;
b) using a first algorithm saved on a file store of a first computer means for generating a first code based on at least some of the collected parameters;
c) using a numbering algorithm saved on a file store of a second computer means for generating a unique code number;
d) combining the first code with the code number and generating a hashed and unique second code which integrates data of the collected physical and/or numeric parameters; and
e) attributing the second code to an electronic/digital banknote.

25. Method according to claim 24, consisting in using the first computer means for carrying out the steps d) and e).

26. Method according to claim 24, comprising the step of using a first algorithm which generates a random code based on hashed and/or converted data of the collected physical and/or numeric parameters.

27. Method according to claim 24, comprising the step of using a numbering algorithm which generates unique and random code number which is combined to the first code.

28. Method according to claim 24, comprising the step of storing the second code on a readable support within a safe and secured environment.

29. Method according to claim 24, comprising the step of using the second code for the identification of an electronic/digital banknote and for the authentication of a numeric transfer of electronic/digital banknotes.

30. Method according to claim 24, comprising the step of using sensed physical parameters of a real banknote sheet produced in a classical banknote production line, prior to the numbering step of the said banknote.

31. Method according to claim 30, consisting in using random fluctuations of the structural and/or printing parameters, which occur during the classical fabrication of a real banknote sheet (paper banknote), for constituting at least some of the collected physical parameters.

32. Method according to claim 31, comprising the step of destroying the banknote sheet after the parameters have been collected.

33. Method according to claim 24, comprising the step of using sensed physical parameters of a physical banknote specimen of an existing banknote.

34. Method according to claim 24, comprising the step of using numeric parameters, generated by CAD means, defining a real banknote sheet which is produced in a classical banknote production line.

35. Method according to claim 24, comprising the step of using sensed physical parameters a physical banknote specimen of an existing banknote sheet and the step of using numeric parameters, generated by CAD means defining the existing banknote sheet which is produced in a classical banknote production line.

36. Method according to claim 24, comprising the step of using the numbering means of a classical banknote production line for generating the unique code number.

37. Machine for generating an electronic/digital banknote by carrying out the method in accordance to claim 24, comprising:
means for collecting physical and/or numeric parameters of an existing banknote;
a first computer means comprising a file store in which is saved a first algorithm for generating a first code based on at least some of collected parameters;
a second computer means comprising a file store in which is saved a numbering algorithm for generating an unique code number; and
software means for combining the first code with the code number for generating a hashed and unique second code and for attributing said second code to an electronic/digital banknote.

38. Machine according to claim 37, wherein the software means are loaded on the first computer means.

39. Machine according to claim 37, wherein the first computer means are integrated in a tamper proof black box.

40. Machine according to claim 37, wherein the means for collecting parameters comprise optical and/or electromagnetic sensor means for recognizing physical parameters of an existing banknote.

41. Machine according to claim 40, further comprising:
an input system for banknote sheets,
a transparent cylinder for transporting the sheets within the sensing area of the sensor means, in order to analyze the said sheets and to collect their physical parameters,
and an extraction cylinder for picking up the sheets from the transparent cylinder after being analyzed and for feeding an evacuation system with the analyzed sheets.

42. Machine according to claim 41, further comprising an additional cylinder cooperating with the extraction cylinder for turning the sheets after the analysis of their first side and for disposing the other side of the said sheets on the transparent cylinder for a complementary analysis.

43. Machine according to claim 41, wherein the sensor means comprise a linear camera and a visible light reflection illuminator arranged outside the transparent cylinder.

44. Machine according to claim 43, wherein the sensor means comprise an infrared or ultraviolet light transmission illuminator arranged in the transparent cylinder, in a position which allows the emission of a transmitted beam of light in the direction of the linear camera.

45. Machine according to claim 41, wherein the evacuation system comprises a translation table for conveying the sheets to a cutting unit for destroying the analyzed sheets.

46. Machine according to claim 37, further comprising connection means and communication means for establishing a data transmission between a remote CAD device and the first computer means, the data corresponding to the numeric parameters of an existing banknote being stored in the CAD device.
